(19) United States
(12) Patent Application Publication
(10) Pub. No.: US 2008/0015968 A1
(43) Pub. Date: Jan. 17, 2008

(54) Fee-Based Priority Queuing for Insurance Claim Processing

(75) Inventors: Andrew Stephen Van Luchene, Santa Fe, NM (US); Raymond Jay Mueller, Palm Beach Gardens, FL (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: Leviathan Entertainment, LLC, Santa Fe, NM (US)

(21) Appl. No.: 11/462,621

(22) Filed: Aug. 4, 2006

Related U.S. Application Data
(60) Provisional application No. 60/727,191, filed on Oct. 14, 2005.

(51) Int. Cl. G06Q 40/00

(52) U.S. Cl. 705/37

(57) ABSTRACT

A document priority queuing system is described wherein a document that is received for processing is assigned a position in a queue and a fee can be paid to change the documents position in the queue. Also provided are mechanisms for ensuring fairness to documents provided by applicants who are unable or unwilling to pay priority processing fees.

### PRIORITY CLAIM AND CROSS-REFERENCE TO RELATED APPLICATIONS

The present application claims priority to U.S. Provisional Patent Application Ser. No. 60/729,191, filed Oct. 14, 2005, the entirety of which is hereby incorporated by reference for all purposes

### BACKGROUND

Many businesses, such as insurance companies, process forms such as insurance applications, claims, and other documents. Typically, companies prioritize such forms based upon the data received and/or the relative importance of the Applicant, such as a customer, client, business account, etc. Oftentimes companies may be overwhelmed by the number of forms in the queue to process and, in these instance, service levels may be suboptimal. In certain cases, such as with insurance companies, local, State and/or Federal laws may control the method and means for the timing, priority and processing of such forms, even though, in some cases, several forms may have greater value to the Applicant or processing entity and/or may have some aspect that provides a degree of “perishability.” Applicants who might need or otherwise desire faster processing of their forms are left with little choice except to wait in line for their form(s) to be processed according to their assigned position in the queue, even in instances where they may be willing to pay for more expedient service.

Therefore, there is a need to permit Applicants, such as insurance claimants or their Attorneys, or other designated third parties to permit certain forms to receive priority status and resolution over other forms within one or more queues.

### SUMMARY

Various embodiments of the present invention relate to the filing, prioritization, management and subsequent processing of forms by Agents within a business entity or other office, entity, or organization. A system and method to determine a value or cost to accelerate processing of one or more forms is disclosed. In an embodiment of the present invention, certain percentages of the proceeds are retained by the processing entity to provide or procure additional funds for hiring additional employees (full, part-time, regular, temporary, contractor, etc.) and/or to provide other resources, such as computing hardware and software, and/or other resources as necessary to relieve resource constraints, bottlenecks and other problems found within the forms processing entity.

In an embodiment of the present invention, certain percentages of additional fees are made available to Agents, employees or others that process forms as an incentive to process higher priority forms and/or to work additional hours to help clear part or all of their or the entire backlog of work/forms. Methods to ensure continued fairness of processing such forms for all Applicants, including those who are unable or unwilling to pay any such additional fees are also disclosed.

### BRIEF DESCRIPTION OF THE DRAWINGS

FIG. 1 is a flow chart of a method for fee-based priority queuing according to one embodiment of the present invention.

FIG. 2 provides a block diagram of an exemplary system according to one embodiment of the present description.

### DETAILED DESCRIPTION

Definitions

Agent—includes an individual, group of individuals, company, local, State or Federal government, agency, administration or any other duly authorized or empowered entity responsible for processing a form or forms submitted by Applicants. Agents may be required to use a central or other automated system to prioritize, review, or otherwise process forms.

Artificial Intelligence—includes any computer program that uses neural nets and/or genetic algorithms, and/or any other learning system.

Applicant—includes any person, or persons, attorney, entity or otherwise that submits one or more forms to Agents for processing. An applicant may be required to be a member of a central or other automated system.

Electronic notification—includes an email or other means of digitally sending a message with a date and time stamp to an electronic address.

Filing Date—shall be the time stamp of the date that a form was submitted to the Agent by the Applicant and/or any third party.

form—includes any message, communication, request, document or form, whether transmitted orally, in writing in hard copy and/or electronic form, including, but not limited to a: letter, insurance application, insurance claim form, insurance adjustment form, request for processing application or form, request or application or documents submitted for review or revision or appeal, purchase or change order, new or change of address or shipping instructions, driver's license or license plate applications or renewal forms, construction, electrical and/or plumbing permit, status update or progress review forms, and the like. forms may be transmitted in any manner including, but not limited to any one or more of a web based application or web based form, online, instant messaging, online chat room, telephone, e-mail, regular mail, facsimile, voice mail, text messaging and the like. forms may also include, without limitation, requests for information, price quotes, requests for permits, releases, notices, judgments or awards, service of legal notice or subpoenas, processing of liens, bank or other loan applications, SEC or other filings or notices, tax filing or applications, social security card processing, passport applications or renewals, so-called green card (i.e., permanent residency status documents) or other immigrant documents processing,

Filed form—includes any form that is submitted by an Applicant or any person or governmental or business entity to an Agent or any third party, including, but not limited to any processing body, agency, insurance company, law firm, business entity, local, State or Federal Government or any of its departments, divisions, or otherwise, or a department within a company assigned the duty or responsibility to prioritize and/or process forms.

Genetic Algorithm—includes a computer algorithm that is capable of modifying and improving itself over time.

Interview—includes an electronically recorded conversation or exchange of forms and/or other Electronic notification or conversation(s) between an Applicant and an Agent and/or any combination of an Applicant, Agent, or any third party representing such Applicant and/or Agent.

Notice of approval—includes any notice sent by an Agent, company, third party or business to an Applicant indicating that the request or action has been approved.

Note of rejection—includes any notice sent by an Agent, company, third party or business to an Applicant indicating that the request or action has been rejected or disallowed.

Online Chat Room—includes any electronic correspondence medium that allows for a real time, electronic conversation between an Agent and an Applicant.

Queue—shall be a file of forms that are or may be assigned to an Agent or group of Agents that require processing and have some form of order or status, including, but not limited to, based upon the order the forms are received by the Agent.

Status Change—includes a change in status of a form as it moves through the review and/or other processes. Changes in status can include but are not limited to submitting the form for initial prioritization, categorizing, assignment, processing, receiving an Electronic notification that a form has been accepted or rejected an any reasons noted (if any), placing the form in a general, segmented or specific Agent's processing Queue, receiving a notice that the form has been allowed or approved, receiving a notice that additional information is required for the form; receiving a submitted date, Time Stamp or other unique identification or processing number for the form, and/or receiving a notice that a form has been moved up or down in any queue and/or is undergoing review and/or processing.

Time Stamp—includes an unalterable recording of the time a form was created by, entered into, received, modified, prioritized and/or processed by a system.

Web-Based Application—includes a computer program or application that is accessible on the World Wide Web via a web browser such as Microsoft's Internet Explorer. The computer program may be stored on a central server and accessed via other computers.

Web-Based form—includes an electronic form used to enter information by an Applicant into a web-based computer program, which may include a form or other documents and/or notes and/or Status change or other notices.

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like means “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” described both “based only on” and “based at least on”.

The term “represent” and like terms are not exclusive, unless expressly specified otherwise. For example, the term “represent” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restrict the meaning or scope of the claim.

The term “e.g.” and like terms means “for example”, and thus does not limit the term or phrase it explains. For example, in the sentence “the computer send data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms means “that is”, and thus limits the term or phrase it explains. For example, in the sentence “the computer sends data (i.e., instructions) over the Internet”, the term “i.e.” explains that “instructions” are the “data” that the computer sends over the Internet.

The terms “determine”, “determining” and grammatical variants thereof (e.g., to determine a price, determining a value, determine an object which meets a certain criterion) is used in an extremely broad sense. The terms “determine” or “determining” encompasses a wide variety of actions and therefore can include calculating, computing, processing, examining, deriving, investigating, looking up (e.g., looking up in a table, a database or another data structure), ascertaining and the like. Also, “determine” or “determining” can include receiving (e.g., receiving information), accessing (e.g., accessing data in a memory) and the like and can also include resolving, selecting, choosing, establishing, and the like.

The terms “determine” or “determining” does not necessarily imply certainty or absolute precision, and therefore can include estimating, predicting, guessing and the like.

The terms “determine” or “determining” does not imply that mathematical processing must be performed, and does not imply that numerical methods must be used, and does not necessarily imply that an algorithm or process is used.

The terms “determine” or “determining” does not necessarily imply that any particular device must be used. For example, a computer need not necessarily perform the determining.

Forms of Sentences.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Disclosed Examples and Terminology Are Not Limiting

Numerous embodiments are described in this disclosure, and are presented for illustrative purposes only. The described embodiments are not, and are not intended to be, limited in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical or electromechanical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the title (set forth at the beginning of the first page of this disclosure) nor the Abstract (set forth at the end of this disclosure) is to be taken as limiting in any way as the scope of the disclosed invention(s). An Abstract has been included in this disclosure merely because an Abstract of not more than 150 words is required under 37 C.F.R. § 1.72(b).

The title of this disclosure and headings of sections provided in this disclosure are for convenience only, and are not to be taken as limiting the disclosure in any way.

Devices that are described as in communication or otherwise connected with each other need not be in continuous communication or connection with each other, unless expressly specified otherwise. On the contrary, such devices need only transmit or be otherwise connected to each other as necessary or desirable, and may actually refrain from exchanging data or electrical current most of the time. For example, a machine in communication with another machine via the Internet may not transmit data to the other machine for a prolonged period (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the other in which they are enumerated.

Computing

It will be readily apparent to one of ordinary skill in the art that the various process described herein may be implemented by, e.g., appropriately programmed general purpose computers and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus, a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many applications, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus, a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one or ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various process, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Continuing Applications

The present disclosure provides, to one of ordinary skill in the art, an enabling description of several embodiments and/or inventions. Some of these embodiments and/or inventions may not be claimed in this application, but may nevertheless be claimed in one or more continuing application that claim the benefit of priority of this form. Applicants intend to file additional applications to pursue Patents for subject matter that has been disclosed and enabled but not claimed in this application.

35 U.S.C. § 112, paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Disclaimer

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature.

### DESCRIPTION OF VARIOUS EMBODIMENTS

While the present invention is susceptible to various modifications and alternative constructions, certain illustrated embodiments thereof have been shown in the drawings and will be described below in detail. It should be understood, however, that there is no intention to limit the invention to the specific application disclosed, but, on the contrary, the invention is to cover all modifications, alternative methods, substituted steps or processes and the like including any and all equivalents falling within the spirit and scope of the claims.

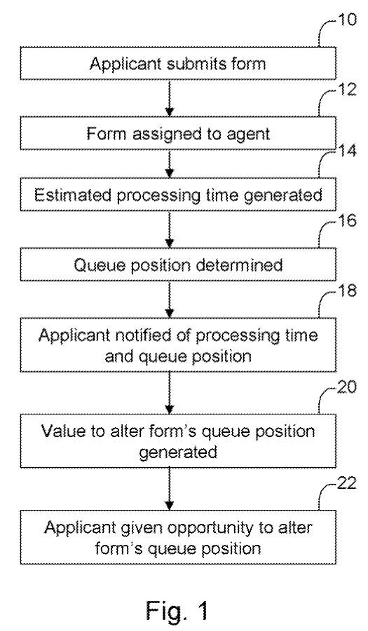

FIG. 1 is a flow chart showing one embodiment of the present invention. At 10, an application submits a form. At 12 the form is assigned to an agent. At 14, an estimated processing time is generated. At 16, the queue position of the form is determined. At 18, the applicant is notified of the processing time and queue position associated with the form. At 20, a value to alter the queue position of the form is generated. At 22, the applicant is given the opportunity to alter the form's queue position.

The applicant for example, may be an insured individual or entity, an interested party, a representative of an insured individual entity, or interested party, or any other person or entity submitting a form.

According to some embodiments, the form may be submitted manually in person, via a paper form transmitted in person or through the mail or other postal carrier, or electronically via a web-based application or other computing system.

The department, division and/or Agent in the agency to whom the form is assigned may be determined manually (e.g. by a person) or automatically via a computer system. A form may be assigned to an Agent based upon any desired criteria including, for example, the Agent's sill, ability, prior experience with similar forms, time expected to process the form or other forms in the Agent's queue, current or expected workload, schedule, time off, and/or the Agent's desire and/or willingness to process prioritized forms with or without an offer of added incentives and/or a share of the processing fee(s) in order to work overtime.

Moreover, the appropriate Agent for a given form might be determined based upon relevancy scores of forms previously processed by the Agent, other forms reviewed and/or other forms pending for that specific Agent, and/or as or if requested by the Applicant or Applicant's attorney, and/or based upon similarity of cases, electronic communications, and/or the Agent's education, training or performance reports.

According to another embodiment, applicants may pay a fee to have a form moved from one Agent's queue to another, preferred, Agent's queue.

The estimated processing time may be based on a variety of factors including, but not limited to, the number of forms that are queued ahead of the Applicant's form, the estimated time it might take for the Applicant's form to be assigned to an Agent, and the expected time it will take the Agent to process the form. For the purposes of the present disclosure, a form may be considered to have been “processed” when the matter is finally disposed of, or at an intermediate time, e.g. when a request for additional information is submitted to the Applicant, or when some type of communication (electronic or otherwise) is transmitted to the Applicant.

The queue position may be based on the number and types of forms that were already submitted to that division and/or Agent. The form may be assigned a specific queue position, i.e. “your form is number 1,284 in the queue,” or simply given a group, or batch assignment, i.e. “your form is in processing group F.”

An agency may assign priority to forms based on any number of priority factors. For example, previously submitted forms that have not yet been processed may be automatically assigned a higher priority than forms submitted at a later date. Alternatively, the initial prioritization may rely on other factors such as nature of the form, estimated processing time for the form, identity of the applicant, etc. Additional priority factors may include, but are not limited to; laws, statutes or regulations, company policies, court order, previous payments for other forms, or submission of information from the Applicant designating the Applicant, or his form(s), as having special circumstances, etc. Examples of special circumstances include, for example, the age of the Applicant, financial difficulty, membership of the Applicant to a protected or special class, such low income (e.g. an income level below the poverty line), unemployment, disability, minority status, or any other special circumstance, status or group that is protected by law, court order, precedence, company policy or common practice and the like.

Numerous methods could be used to generate a value (or cost) to move the Applicant's form in the queue relative to the other forms. According to various embodiments, the value of moving a form up (or down) in any given queue can be determined by any one or more of the following, including, but not limited to: a) the value assigned to the queue position of other forms in the same queue, b) the cost paid by other Applicants within the same queue or all queues, c) the amount of time that would be saved by moving up one or more positions in the queue, d) competitive bids from other Applicants to move their forms up one or more positions in the queue and/or to retain their present position, e) the total workload or hourly or other costs of any given Agent or group of Agents within a given queue or multiple queues, f) the relative value or cost as determined by the system for other forms g) statutory regulations or guidelines established by any duly authorized body, including any government or oversight committee or agency or otherwise, h) auction or reverse auction processes, i) a group or association of Attorneys and/or Agents, and/or a Applicant group created for the purpose of establishing such pricing, j) the total number of forms awaiting processing within a queue, sub-queue, Agent, group of Agents, or in the aggregate, and/or k) any other method determined or agreed upon or by the business entity, governing body, or any associations or user groups established by the Agent, company, Applicant(s) and/or the appropriate entity, and/or by the system or any other method as agreed upon or established by agreement and/or prevailing law, or any combination of these methods.

According to a still further embodiment, at any time before (or while) a form is processed by an Agent, an Applicant may be given the opportunity to alter the queue position of his form. According to one embodiment, the Applicant may be able to alter the queue position of his form by paying a fee, submitting something of value, and/or consenting to certain requirements. The amount paid may be determined by the value determined in the paragraph above, or may be a combination of some percentage greater or lesser) of the above-determined value and some other factor. Moreover, the applicant may similarly be given an opportunity to receive a fee reduction, payment, or some other value in exchange for permitting the agency to move his form down in a queue.

According to some embodiments, queue positions may be assigned to individual documents, or to batches of documents in the queue. For example, a given queue may have 10 queue positions. This may indicate that there are 10 documents in the queue, each occupying a different position. Alternatively, there may be 300 documents in the queue, with each queue position holding approximately 30 documents. Applicants may be notified that they can move their document up to a given position in the queue by paying a particular fee. For example, an applicant may be able to move a document from position 10 to position 5 by paying a moderate fee, such as $500, or from position 10 to position 1 by paying a large fee, such as $2000. The amount of the fee may be based entirely on the position (i.e. you always have to pay $2000 to move to position 1, no matter where you start) or based on the number of positions that are jumped (i.e. moving a document from position 10 to position 1 costs more than moving from position 5 to position 1).

According to yet another embodiment of the present invention, form(s) cannot be priority queued unless the Applicant who submitted them agrees to perform or not perform certain actions. For example, in order to have a form priority queued, an Applicant may have to agree to permit the form to be published or otherwise scrutinized by the public or other individuals or groups a) as soon as it is filed; and/or b) as soon as the Agent begins processing the form; and/or c) when or if the Agent cites it as relevant to any other form that has been moved up or down in the queue; and/or d) at any other such time as determined by the processing entity, governing body or agency or other authority and/or user or professional group, including user groups, Agent groups, Applicant Groups, legal associations, and the like, and/or any local, State of Federal law, statute or guideline.

According to still another embodiment, if a first applicant's form is displaced or will be displaced by a second applicant's priority queued form (e.g. if the second applicant pays a priority queuing fee to move his form past the first applicant's form), a notice can be sent to the first applicant. The applicant whose form is displaced may be permitted to submit commentary to the Agent (and/or processing entity) explaining why his form should have a “higher priority,” may receive a “right of first refusal” to deny priority queuing to the second applicant's form, and/or may pay an amount or submit a bid to retain the form's position in the queue and/or to have his form advanced in the queue.

According to some embodiments, to ensure that Applicants that do not possess the resources necessary to pay to retain or improve their position within the queue are protected and/or given opportunities for their forms to receive preferential treatment, one or more of several procedures, policies, methods or steps may be employed (voluntarily or by law) including, but not limited to:
a) the processing company or office, may allocate a certain percentage of each Agent's time and/or all of a group or pool of Agents toward prosecuting forms in due course, i.e., as in existing processes, such percentage may be the majority or some other portion of the Agent's time,
b) incentives may be offered to one or more Agents to prosecute certain applications or forms, including those that have or have not been advanced in the queue,
c) in order to obtain the right to improve the position within the queue, Applicants, and/or their attorneys or other designees may be required to provide processing or other services directly or indirectly to the processing office and/or to Agents, and/or to other Applicants, in exchange for, or in addition to payments made for such privileges (i.e. indentured services),
d) certain percentages of the fees collected from Applicants to improve their position within a queue may be allocated to more needy or all or some of the Applicants that request such prioritization and whose forms warrant priority queuing as determined by any one or more of i) the system, ii) the Agent, iii) a committee established by Congress, and/or any other duly authorized oversight committee and/or governing body, and/or the committee itself, iv) documented evidence of financial need or hardship as submitted by Applicant or Applicant's attorney,
e) forms for which priority queuing fees have not been submitted may be randomly assigned a queue position,
f) a percentage of each fee paid to change the priority of any given form may be used to hire additional resources to offset the time lost examining the prioritized form(s) and/or to reduce the time required to process any or all forms in the queue, whether or not they have been prioritized (which may result in an acceleration in the processing of all forms, i.e., funding from prioritized forms may fund the resources required to process all or the remaining forms in the queue (or only those forms from Applicants showing financial need or other documentation justifying a request for priority), thus serving the greater good of all Applicants and, in some cases, society as a whole),
g) the age or financial capacity of the Applicant may be considered as a factor in assigning a form's queue position,
h) the total number of forms in the queue from the Applicant and/or a ratio of prioritized vs. non-prioritized forms may be considered as a factor in assigning a form's queue position,
i) the “perishability” of the form or claims made in the form may be considered as a factor in assigning a form's queue position,
j) any other factors or variables established from time-to-time by Congress, or by the insurance or other company or processing entity, and/or any other duly authorized governing authority or, in the case of a foreign country, their laws and/or committees and/or any governing bodies, etc. may be considered as a factor in assigning a form's queue position,

According to an embodiment of the present invention, to ensure that forms that have not paid to be placed in a priority position are processed, only a certain percentage of the total forms processed by an Agent may be priority queued forms. For example, only 10% of the forms any individual Agent is assigned could be priority queued. An Agent then may be given a batch of forms at a time, only a given percentage of which are priority queued forms. The form that is priority queued may or may not be known to the Agent. Moreoever, the agent may be required to process the entire batch of forms before being assigned another batch.

According to a further embodiment of the present invention, the percentage of priority queued forms vs. standard non-priority queued forms that an Agent must review in a block an be variable and based on any one or more of:
(i) the percentage of total forms filed that are priority queued
(ii) the percentage of forms that are assigned to a particular group or subgroup that are priority queued
(iii) by law, governing body, Applicant group, company, or other processing entity
(iv) the willingness and availability of one or more Agents to process forms after hours,
(v) the estimated time required to process forms (whether or not prioritized) vs. the available hours or other resources required to process such forms, and/or
(vi) any combination of these options and/or methods as defined by law and/or any duly authorized governing body.

According to a further embodiment, the Agent may receive a bonus once the entire batch of forms is processed. Alternatively or additionally, the agent may receive progress bonuses that are in equal amounts and/or increase or decrease as the batch is processed. This bonus may only be issued when all the forms in a batch have been processed by a certain time period. An auditor or supervising Agent can review all or a percentage of the total forms of an Agent including those processed vs. those waiting to be processed. If the auditor does not agree with the decision(s) made and/or the work performed by the processing (i.e., responsible) Agent, part or all of the entire Agent's bonus may be forfeited and the Agent may be further penalized or prohibited from participating in further bonuses going forward for some proscribed period of time.

The bonus amount to be paid to an Agent, group of Agents and/or others providing services or processing, which may include Auditors, assistants and other individuals or groups, to review the forms may be determined based upon the priority queue fee of the forms in the group. For example, if two of the forms in batch have a priority queue value of $121,300, the Agent could receive $1,213 or 1% of the priority queue fee as a bonus for reviewing all ten forms. The percentage of the priority queue fee that the Agent receives as a bonus could be based on any one or more of the following, including, but not limited to: (i) how long the Agent has worked for the processing office (ii) how many times an Agent failed part or all of an audit (iii) how quickly the Agent has processed his forms in the past and/or (iv) how many forms are presently in the Agent's queue, and/or (v) any combination of the above and/or (vi) any other bonus program as determined by the system, company, legal entity, law or other duly authorized governing body.

The priority queuing fee can be charged at any time. For example, a fee may be changed when a form is filed, assigned an initial or subsequently modified queue position, and/or when the form is processed. Fees may be paid as a single lump sum or in incremental payments.

According to an embodiment, in order to move a form up in the processing queue, the Applicant (or Applicant's attorney or other Applicant designee) may be required to fund part or all of the processing fees of a certain×number of other Applicant's forms who are not or are otherwise unable or unwilling to pay to have their forms processed and/or moved up within the queue.

For example, forms that have been moved up or down in priority one or more times, may be flagged to prevent further movement in their priority relative to other forms within the queue and/or such forms or Applicants may receive an option to maintain and/or improve their relative position for a fee that may be less than or substantially less than (or greater than or equal to) subsequent fees paid by other Applicant's to move their forms up within the queue. Alternatively, Applicants could pay yet another fee to more rapidly process any forms(s) that are ahead in the queue, thus freeing resources to examine the pending form(s) that had been previously moved within the queue or otherwise.

In one embodiment, the position in queue may only be altered before the form has been assigned to an Agent. Alternatively, a form may receive additional resources and/or higher priority status even after the form has been assigned and/or processing has begun but has yet to be completed.

It should be appreciated that a system configured to implement any or all of the above embodiments can be built utilizing many different architectural methods including, but not limited to: 1) a simple, table based method 2) a rules based system or 3) an artificial intelligence (AI) system such as neural Net, Bayesian or other Genetic Algorithm.

Alternatively or additionally, the system may simply be a manual process implemented in response to the creation of policies, procedure and/or rules established by law or by the processing office, e.g., insurance agency or construction inspector's office.

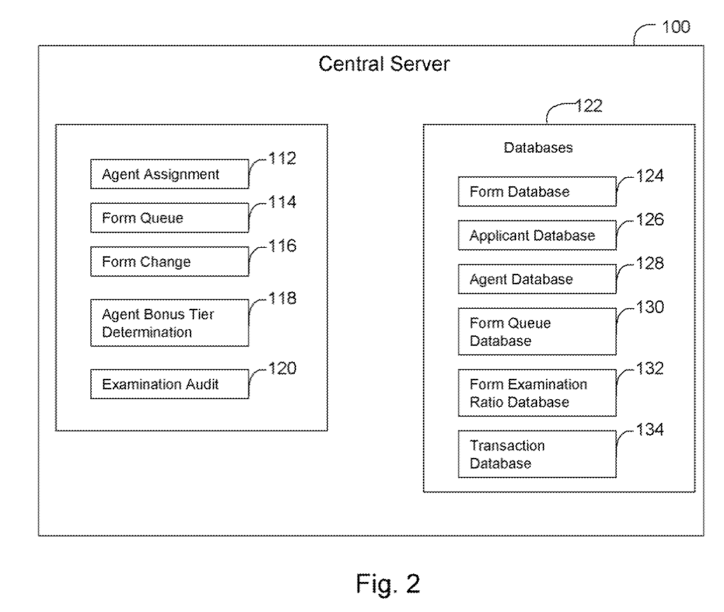

An exemplary system 100 configured to implement one or more of the embodiments described above is shown in FIG. 2.

As shown, FIG. 100 includes a Central Server 112 configured to run or implement various programs such as, for example, an agent assignment program 114, a form queue program 116, a form change program 118, and agent bonus tier determination program 120 and an examination audit program 122. Moreoever, central server 112 may further host or have access to a plurality of databases such as, for example, a form database 124, an applicant database 126, an agent database 128, a form queue database 130, a form examination ratio database 132, and a transaction database 134.

Agent Assignment Program 114 may be configured to a) determine the group and/or sub-group of a form and/or the type of form and/or type of claim(s) made within the form and/or other characteristics of the form or claims, and b) assign a form to a given Agent or Agents based upon any one or more of the Agent's skill, experience, backlog, willingness or desire to work additional hours (with or without added incentives and other criteria determined in step a above.

Form Queue Program 116 may be configured to a) initially assign a queue position in the processing line to a form, b) record the information in a queue database, c) notify the Agent(s), Applicant(s), including Applicant or Applicant's attorney, d) determine the estimated time to process the form given all other forms in the queue including any previously prioritized forms, e) retrieve queuing change requests from the form Queue Change Program and f) optionally makes all such queuing information available to the Agent Assignment and form Change Programs, and/or the public via the Internet or other network.

Form Change Program 118 may be configured to a) retrieve information from the form Queue Program, b) receive requests for queue changes from Applicants, c) determine the value or cost to make such changes within the queue, which change may or may not include additional fees to fund additional resources to accelerate the remaining forms processing d) notify the Applicant and any potentially affected Applicants whose form priority may be altered, e) process any first rights of refusal to maintain an existing priority, f) process fees paid by Applicants based upon the cost previously determined, g) notify the form Queue Program of any changes to one or more forms, and h) make all such queuing information available to the Agent Assignment Program, Central Server (if any) and/or the public via the Internet or other network.

Agent Bonus Tier Determination Program 120 may be configured to determine a bonus tier or bonus amount for each Agent based on performance criteria including any one or more of: a) the number and type of forms, b) the complexity of the case or claims, and/or c) the total amount available for a given form or group of forms or all pending forms or Applicants that are or are willing to pay to accelerate processing and/or change position within an Agent's queue.

Examination Audit Program 122 may be configured to initiate an audit of an Agent's work.

Form Database 124 may include information such as:
a. Form ID
b. Form Group
c. Form Subgroup
d. Form Text
e. Form Diagrams 1-N
f. Form Images 1-N
g. Applicant ID(s) 1-N
h. Form Profile
i. Form Processing Time Estimate
j. Changes in Queue Log File 1-N
k. Form Type (priority queued or not priority queued)

Applicant Database 126 may include information such as:
a. Applicant D
b. Applicant Billing info
c. Applicant Contact Info

Agent Database 128 may include information such as:
a. Agent ID
b. Agent Name
c. Agent Profile
d. Previously Process forms 1-N
e. Past Performance Data
f. Current Division (group and subgroup)
g. Bonus tier

Form Queue Database 130 may include information such as
a. Form ID Number
b. Agent ID
c. Queue Position Number
d. Fee for Queued Position

Form Examination Ratio Database 132 may include information such as:
a. Form Ratio
b. Form Group ID
c. Form Group Ratio
d. Form Subgroup ID
e. Form Subgroup Ratio

Transaction Database 134 may include information such as:
a. Transaction ID number
b. Applicant ID number
c. Form ID number
d. Transaction Amount

Accordingly, system 100 may be configured to determine the ratio of priority queued vs. standard forms for an Agent to review by performing the following steps:
a. Retrieve pending forms in a group or subgroup that have not yet been assigned to an Agent, including information about whether each form is priority or standard queued
b. Determine a ratio of priority and standard filings for a form based on total forms filed, and the group and subgroup of a submitted form.
c. Store ratio

Alternatively or additionally, system 100 may be configured to determine an Agent bonus tier by performing the following steps:
a. Receive and Generate performance criteria for an Agent
b. Determine a bonus tier based on performance criteria
c. Store bonus tier with Agent record.

Alternatively or additionally, system 100 may be configured to assign a block of forms to an Agent based on ratio by performing the following steps:
a. Receive a request to process a block of forms by an Agent
b. Retrieve the priority vs. standard ratio for the particular Agent based on the group and subgroup of forms that Agent reviews.
c. Assign a block of forms to the Agent in the ratio of priority vs. standard
d. Determine a bonus to pay the Agent when the block of forms has been processed based on the priority queue fees of the priority forms in the assigned block and the bonus tier assigned to that Agent.
e. Output assigned block to Agent, including bonus amount

Alternatively or additionally, system 100 may be configured to audit a form processing to approve bonus by performing the following steps:
a. Receive an indication that a block of forms has been processed by an initial Agent
b. Determine at least one of the processed forms to reexamine
c. Output reexamination request to a second Agent
d. Receive an indication that a reexamination is complete
e. If reexamination result confirms initial processing, confirm bonus for initial Agent for processing of block of forms
f. If reexamination result conflicts with initial processing result, deny bonus for initial Agent for processing of block of forms

Alternatively or additionally, system 100 may be configured to establish Initial Position of form in Queue by performing the following steps:
a. Receive form including form type
b. Determine Agent for form
c. Retrieve Existing form Queue and Values for positions in the Queue of the Agent
d. Determine Estimated Time to Complete Examination
e. Output form Queue of Agent with corresponding values
f. Receive or determine value of form
g. Place form in queue based on value assigned
h. Update databases
i. Publish value and queue position

Alternatively or additionally, system 100 may be configured to notify Applicant if Position in Queue is or may be Lost by performing the following steps:
a. Receive form and value
b. Determine place in queue based on value
c. Determine previous forms in the queue whose queue values have changed as a result of the form being submitted
d. Retrieve Applicants associated with previous forms
e. Notify Applicants of previous forms that the queue position of their forms has changed.
f. Publish results
g. Update databases and return to controlling application.

Alternatively or additionally, system 100 may be configured to charge for a change in queue position by performing the following steps:
a. Receive request to improve position within the queue from Applicant
b. Determine price based upon queue variables including, any one or more of: number in queue, price of any previously moved within the queue, submitted or required or determined price based upon market forces, policy, procedure, precedence, law, or otherwise.
c. Notify Applicant of price
d. Receive acceptance of price and payment from Applicant
e. Execute “Protect existing forms subroutine”
f. Determine if one or more forms are eligible or ineligible to be moved based upon results from sub-routine
g. If yes, execute “Subsidy sub-routine”
h. As appropriate, update affected forms position within the queue and, if appropriate, process payment from all affected Applicant(s)
i. Update databases
j. Publish results

Alternatively or additionally, system 100 may be configured to protect an existing forms subroutine by performing the following steps:
a. Receive indication that a form may be affected by a pending change in queue request)
b. Execute Notify Applicant if Position in Queue is Lost
c. Receive notice from any existing Applicant(s) that desire to exercise their first right of refusal and/or determine if any existing forms may be affected for a second (or more times)
d. Update costs (if any) to change or maintain position within the queue (for new and existing Applicants)
e. Receive payment from Applicant exercising first rights
f. Update databases and return to controlling application.

Alternatively or additionally, system 100 may be configured to perform the following steps:
a. Notify Applicant that one or more pre-existing forms have exercised their first right and/or may not be moved again.
b. Determine price for Applicant to pay for processing or accelerating such forms
c. Execute indentured service subroutine
d. Notify Applicant of price or service time required to improve their position in the queue and the price to subsidize and/or accelerate such other forms' processing
e. Receive rejection or acceptance and payment from Applicant
f. Update databases and return to controlling application.

Alternatively or additionally, system 100 may be configured to select an Agent by performing the following steps:
a. Determine Group and Subgroup of form
b. Determine workload of all Agents qualified or assigned to Applicant's group or subgroup
c. Determine estimated time to complete existing workload for all affected Agents
d. Notify potential Agent(s) to determine if one or more are willing to accept this form in exchange for an incentive.
e. Select best Agent to assign form based upon any one or more of the Agent's workload, skill level, experience with similar forms and/or claims, willingness to accept additional work, price for additional work or overtime work, Applicant's preferences, etc.
f. Update databases and return to controlling application.

Alternatively or additionally, system 100 may be configured to allocate resources by performing the following steps:
a. Receive additional paid in fees to accelerate, subsidize or maintain a position in a queue.
b. Based upon historical and predicted payments, estimate future revenue streams allocable to additional resources
c. Determine which queue(s) have the most time consuming backlogs
d. Allocate additional paid in fees based upon ratio of time required to available money or such other calculation method as desired by the processing office and/or by law or otherwise, and/or as determined by an Al or learning system which determines the best method for allocating such resources.
e. Notify appropriate personnel of availability and duration of funds for use in hiring additional processing resources or for the purchase of hardware, software or programming or other consulting services.
f. Update databases and return to controlling application.

Alternatively or additionally, system 100 may be configured to perform the following steps:
a. Determine or receive time required to process Applicant's form(s).
b. Determine number, type and other variables of those existing forms that might or would be displaced should Applicant's form(s) be moved to the requested or other position(s) within the queue or moved to another Agent's queue.
c. Determine total hours displaced by Applicant's form or revised position in queue and/or new queue.
d. Determine total hours of service required by Applicant's form
e. Notify Applicant and/or Applicant's attorney of service requirement
f. Receive acceptance or rejection notice from Applicant or Applicant's attorney to provide service requirement.
g. Update databases and return to controlling application.

What is claimed is:

1. A method comprising:
providing a document queue;
identifying positions in the document queue;
associating an expected resolution date with each position in the queue; and
receiving a fee in return for moving a document from a first position in the queue to a second position in the queue, thereby creating a priority queued document.

2. The method of claim 1 further comprising assigning the document to a first agent.

3. The method of claim 2 further comprising receiving a fee to reassign the document to a second agent.

4. The method of claim 2 wherein the agent receives a plurality of documents which are grouped together as a single batch.

5. The method of claim 4 wherein the batch of documents includes both priority queued documents and non-priority queued documents.

6. The method of claim 5 wherein the priority queued documents are not specifically identified to the examiner.

7. The method of claim 4 wherein an agent must process al documents in a batch before the agent can be assigned another batch.

8. The method of claim 7 further comprising providing a bonus to the agent when all the documents in the batch are processed.

9. The method of claim 1 further comprising determining a fee to move the document from a first position in the queue to a second position in the queue.

10. The method of claim 5 wherein determining a fee comprises receiving competitive bids.

11. A method comprising;
submitting a document to a document queue;
determining the position of the document in the document queue;
paying a fee to move the document from a first position in the queue to a second position in the queue.

12. The method of claim 11 further comprising bidding to move the document from the first position to the second position.

13. The method of claim 11 further comprising receiving an incentive to allow other forms to be moved to a higher position in the queue.

14. The method of claim 11 further comprising determining an agent assigned to the document and paying a fee to transfer the document to another agent.

15. The method of claim 11 further comprising agreeing to a condition in addition to the fee payment before the document is moved from the first position in the queue to the second position in the queue.

16. The method of claim 15 wherein the condition is allowing the document to become publicly available.

17. A document processing system comprising:
a first module configured to
receive a document from an applicant;
assign it a position in a queue; and
assign the document to an agent able to process the document to a resolution according to the document's position in the queue;
a second module configured to identify to the applicant an expected resolution time for the document according to the document's position in the queue; and
a third module configured to
receive a payment from the applicant; and
alter the document's position in the queue based on the payment.

18. The document processing system of claim 17 wherein the third module is further configured to:
receive competitive bids from a plurality of applicants;
determine a bid winner; and
alter the document position of the document belonging to the bid winner.

19. The document processing system of claim 17 wherein the first module is configured to assign a plurality of documents to the agent in a batch.

20. The document processing system of claim 19 wherein a batch must include both priority queued documents and non-priority queued documents.
